(19) United States
(12) Patent Application Publication
(10) Pub. No.: US 2010/0326289 A9
(43) Pub. Date: Dec. 30, 2010

(54) Shortening saving fryer with automatic filtration

(75) Inventors: Michael A. Theodos, Bossier City, LA (US); Charles Milton Hutchinson, Shreveport, LA (US); Joshua Cox, Shreveport, LA (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: FRYMASTER CORPORATION LLC.

(21) Appl. No.: 11/900,064

(22) Filed: Sep. 10, 2007

Related U.S. Application Data
(60) Provisional application No. 60/962,046.
(60) Provisional application No. 60/952,138, filed on Jul. 26, 2007.

(51) Int. Cl. A47J 37/12; A47J 37/00

(52) U.S. Cl. 99/408; 99/416

(57) ABSTRACT

A deep fryer having a plurality of fryer pots disposed in the deep fryer. Each of the plurality of fryer pots having a first temperature sensor, a second temperature sensor a drain valve and return valve. The system further has a controller that is pre-programmed to count a number of cooking cycles. After the first temperature sensor senses a first predetermined temperature, oil drains from the fryer pot through the drain valve and when the second temperature sensor senses a second predetermined temperature the oil has substantially returned to the fryer pot through the return valve.

This application claims benefit of U.S. Provisional Patent Application Ser. No. 60/962,046 filed on Jul. 26, 2007, the contents of which are incorporated by reference herein.

### BACKGROUND OF THE INVENTION

1. Field of the Invention

This disclosure relates to deep fryers for the food service industry. More particularly, this disclosure relates to deep fryers that are capable of filtering used oil to conserve the oil and to the oil filtering process. Still more particularly, this disclosure relates to deep fryers that are capable of filtering used oil to conserve the oil and to the oil filtering process wherein the process uses thermal sensor feedback to monitor the location of oil in the fryer.

2. Description of Related Art

Deep fryers are a necessity of the food service industry and particularly for the fast food service industry. Deep fryers use a substantial amount of shortening or oil during the cooking process. During the cooking process much of the oil is absorbed by a food product, resulting in loss of oil volume. The remaining oil can become filled with debris due to constant use. Accordingly, there is a need to extend the usable life of the unabsorbed oil and to keep the unused oil clean during the cooking process.

Accordingly, there is a need for a deep fryer that automatically filters used oil in a continuous filtering loop using sensor feedback.

### SUMMARY OF THE INVENTION

The present disclosure provides for a deep fryer that filters used cooking oil to extend the life of the cooking oil, using feedback from temperature sensors.

The present disclosure also provides for a deep fryer that has a closed loop oil filtering system for removing debris from the cooking oil.

The present disclosure provides for a deep fryer system that is capable of filtering oil using temperature sensor feedback to ensure correct location of the oil in the deep fryer.

The present disclosure further provides for a method of filtering cooking oil in a deep fryer that is based on feedback from temperature sensors in the deep fryer.

The present disclosure still further provides for a method of filtering cooking oil for a plurality of fryer pots using a manifold to collect cooking oil and a pump associated with each deep fryer.

The present disclosure further provides for a plurality of fryer pots that are controlled using a centralized system that uses sensory feedback to ensure filtering steps are performed in the correct timed sequence.

The present disclosure provides for a deep fryer that provides at least two sensors; one of the two sensors is a temperature sensor to ensure oil is in the deep fryer to commence the filtration cycle and the other of the two sensors ensures that the oil has reached the desired height in the pot during the filler operation.

The present disclosure still yet further provides for a deep fryer having slots at its lower edge proximate the oil return valve to disperse oil in a spray pattern, the spray pattern ensures that crumbs on the bottom surface of the deep fryer will be flushed.

Accordingly, there is a need for a centralized process that controls the automatic filtering operation of a deep fryer having a plurality of fryer pots, by using feedback from temperature sensors and timers that control the operation of the pumping and filling operations in each pot.

These and other further benefits and features are provided by an automatic filtration system for cooking oil in a deep fryer having a plurality of fryer pots disposed in the deep fryer. Each of the plurality of fryer pots having a first temperature sensor, a second temperature sensor, a drain valve and return valve. The system further has a controller that is capable of counting the number of cooking cycles of a particular fryer pot. After the first temperature sensor senses a first predetermined temperature, oil drains from the fryer pot through the drain valve and when the second temperature sensor senses a second predetermined temperature the oil has substantially returned to the fryer pot through the return valve.

An automatic filtration system for cooking oil in a deep fryer having a deep fryer and a plurality of fryer pots disposed in the deep fryer. Each of the plurality of fryer pots having a first temperature sensor, a drain valve, a second temperature sensor, a return valve associated therewith and at least one slot proximate the drain valve. The system further includes a controller. After the first temperature sensor senses a first predetermined temperature, oil drains from the fryer pot through the drain valve and when the second temperature sensor senses a second predetermined temperature the oil returns to the fryer pot through the return valve and the at least one slot.

### BRIEF DESCRIPTION OF THE DRAWINGS

Other and further benefits, advantages and features of the present invention will be understood by reference to the following specification in conjunction with the accompanying drawings, in which like reference characters denote like elements of structure and:

FIG. 1 illustrates a top perspective view of a deep fryer having two fryer pots, each fryer pot having two temperature sensors, according to the present invention;

FIG. 2 illustrates a front view of the deep fryer of FIG. 1 according to the present invention;

FIG. 3 illustrates a rear view of the deep fryer of FIG. 1 showing the manifold and filtering system components, according to the present invention;

FIG. 4 illustrates a top perspective view of the a fryer pot of FIG. 1 with a heating element and two temperature sensors, according to the present invention;

FIG. 5 illustrates an exploded view of a filter pan of the present invention;

FIG. 6 illustrates a side view of the fryer pot of FIG. 4 having, a linear motion actuators, a drain valve and a return valve, according to the present invention; and

FIG. 7 illustrates a top perspective view of fryer pot of FIG. 4, having spray slots, according to the present invention.

### DETAILED DESCRIPTION OF THE PREFERRED EMBODIMENT

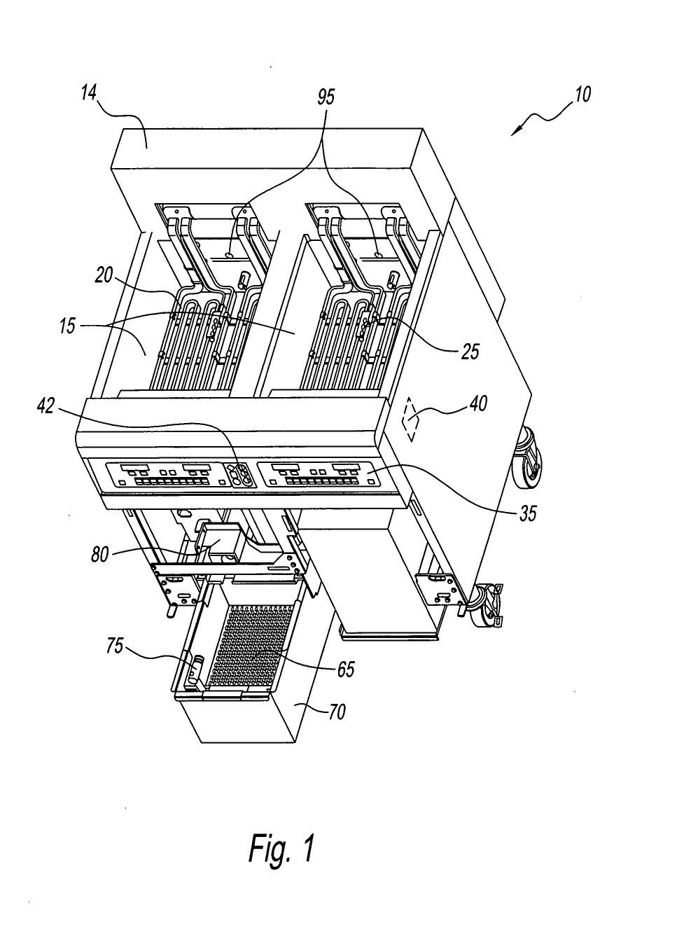

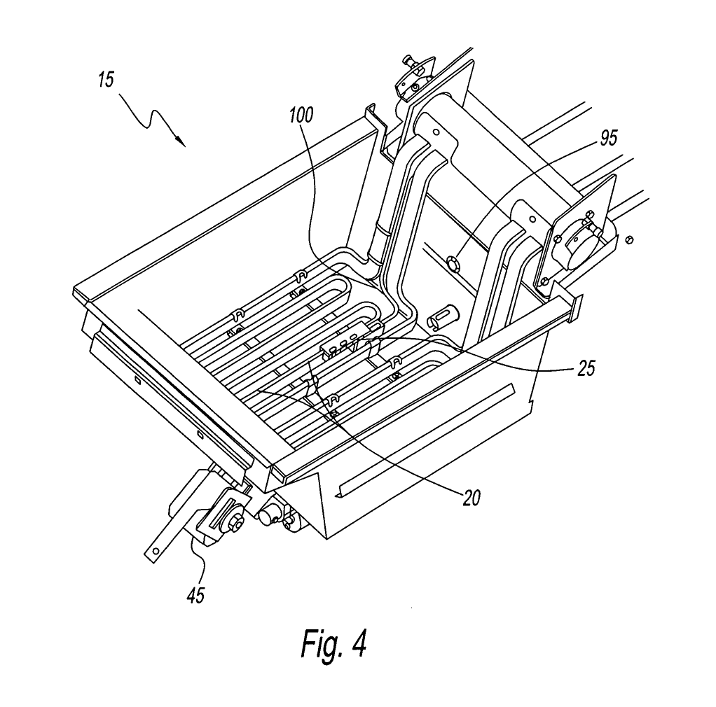

Referring to FIG. 1, a deep fryer is shown, and generally referred to by reference numeral 10. Deep fryer has a housing 14 and two fryer pots 15 that are each used for cooking the same or different foods. Referring to FIG. 4, each deep fryer pot 15 has a heating element 20 proximate to its lower surface. Adjacent to each heating element 20 is a temperature sensor 25. Each fryer pot 15 also has a temperature sensor 95 located on a side wall to provide temperature feedback as the fryer pot is filled. Sensors 25 and 95 could also be bi-metallic switches or any other temperature sensor capable of providing temperature feedback.

Deep fryer 10 has a control panel 35 that is associated with each fryer pot 15. Control panel 35 is operatively connected to a controller 40 that monitors the operation of sensors and timers associated with each fryer pot 15. Controller 40 can accept various settings, such as, for example, temperature and timing settings. For example, controller is 40 is capable of counting the number of times cooking cycles processed in a fryer pot 15. After a predetermined temperature has been sensed, and a number of cooking cycles have been counted, the automatic filtration can be initiated. Alternatively, after a predetermined temperature has been sensed, the control panel 35 prompts the user with filter cycle indicator 42, such as a lamp or an audible indicator for manual operation of the initiation of the automatic filtration cycle with or without a counted number or basket cycles. Controller 35 permits user selection of either automatic or manual operation.

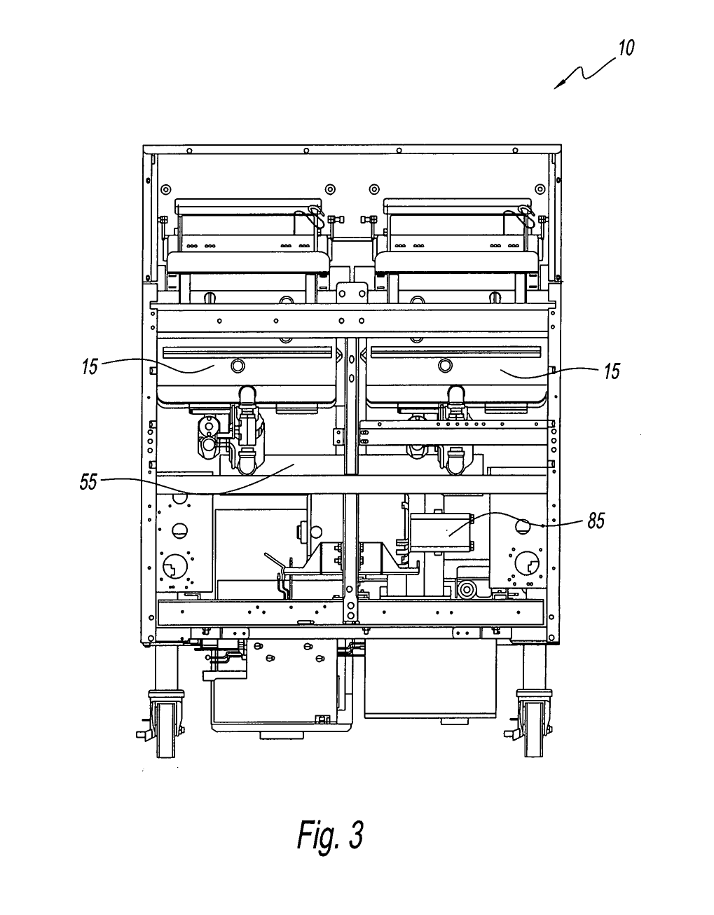

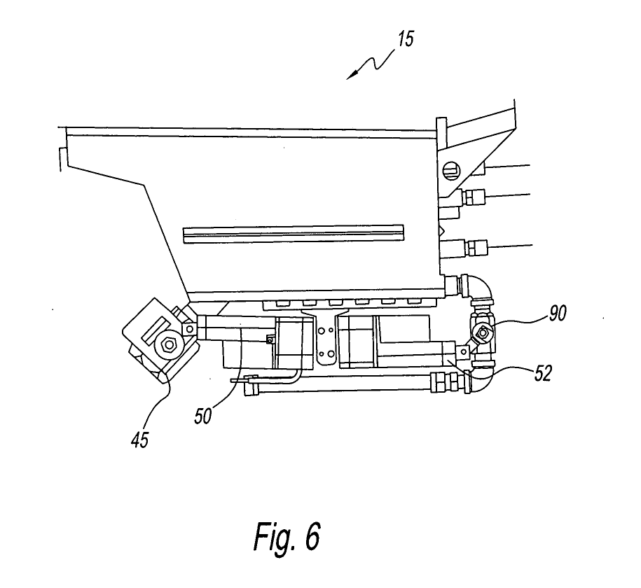

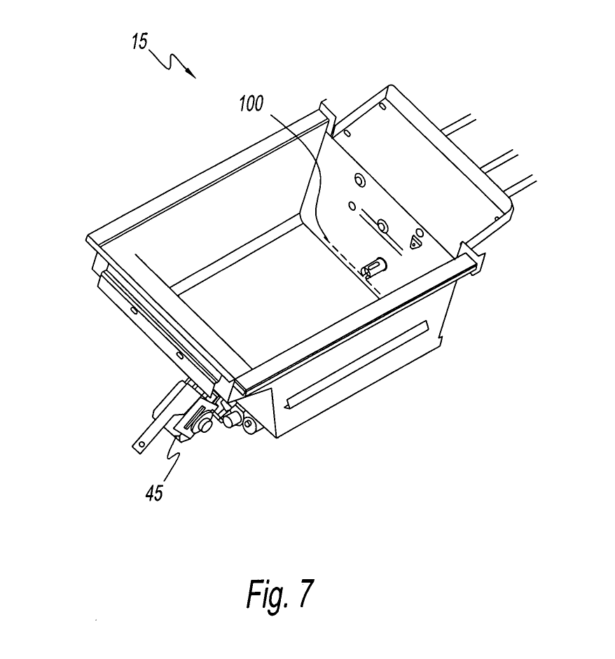

Referring to FIGS. 1 through 7, the components of the oil filtration cycle are described in sequence. Prior to commencement of a filtration cycle, a bubbling period of from approximately 5 to 15 second disturbs any debris that may have come to rest on the inner surface of fryer pot 15. Air for the bubbling period is introduced to each fryer pot 15 by return valve 90. Each fryer pot 15 has a drain valve 45 that is opened and closed by a linear actuator 50. Drain valve 45 has a diameter of approximately 1.25 inches in its fully open position to prevent clogging by debris formed during the cooking process. Linear actuator 50 is either automatically or user activated by operation of controller 40 following prompting by filter cycle indicator lamp 42 on control panel that will commence draining of fryer pot 15. Beneath each fryer pot 15 is a drain manifold 55 that collects oil from drain valves 45 of each fryer pot 15. Manifold 55 collects oil from each drain valve 45 in deep fryer 10. While instant deep fryer 10 shows two fryer pots 15, there could be as many as twelve fryer pots in a deep fryer.

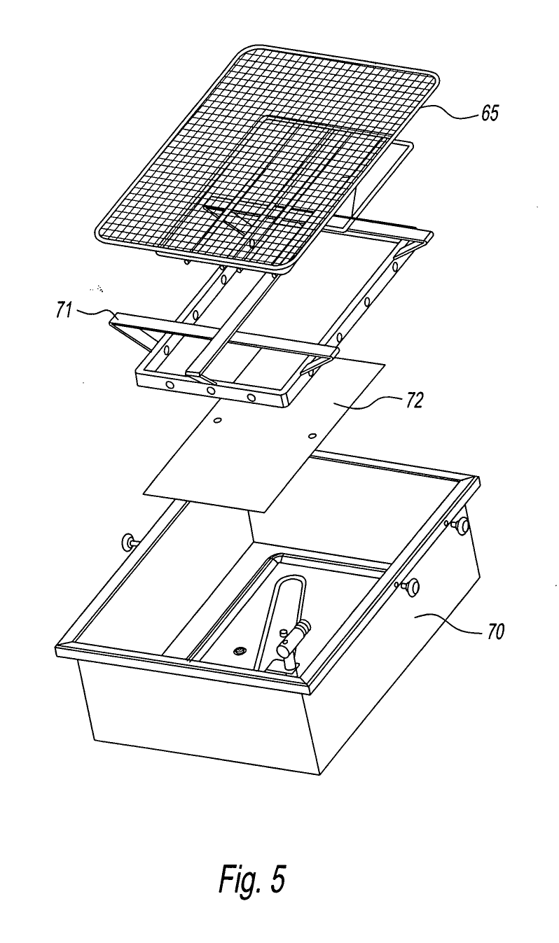

Oil passes from drain manifold 55 to crumb basket 65, via downspout 60. Crumb basket 65 is a preliminary filter that removes large pieces of residual food product from oil. Referring to FIGS. 4 and 5, after oil passes through crumb basket 65, it is deposited in filter pan 70. As oil passes through filter pan 70, it is pulled through a filter pad 72 located in the bottom of filter pan 70. Filter pad 72 has a series of ridges and grooves on the lower surface thereof to permit oil to flow around pad 72. Filter pan 70 contains a hold down ring 71 to maintain position of filter pad 72. Filter spout 75 and filter spout receiver 80 transfer filtered oil to filter pump and motor assembly 85. Filter pump and motor assembly 85 push oil through return valve 90, when it is in an open position, to return oil to fryer pot 15. Return valve 90 is opened and closed by a linear actuator 52. Return valve 90 has a much smaller diameter of approximately 0.5 inches, in comparison to drain valve 45. Drain valve 45 must be able to accommodate debris from bottom of fryer pot whereas, oil entering return valve 90 would have already been filtered by crumb basket 65 and filter pad 72.

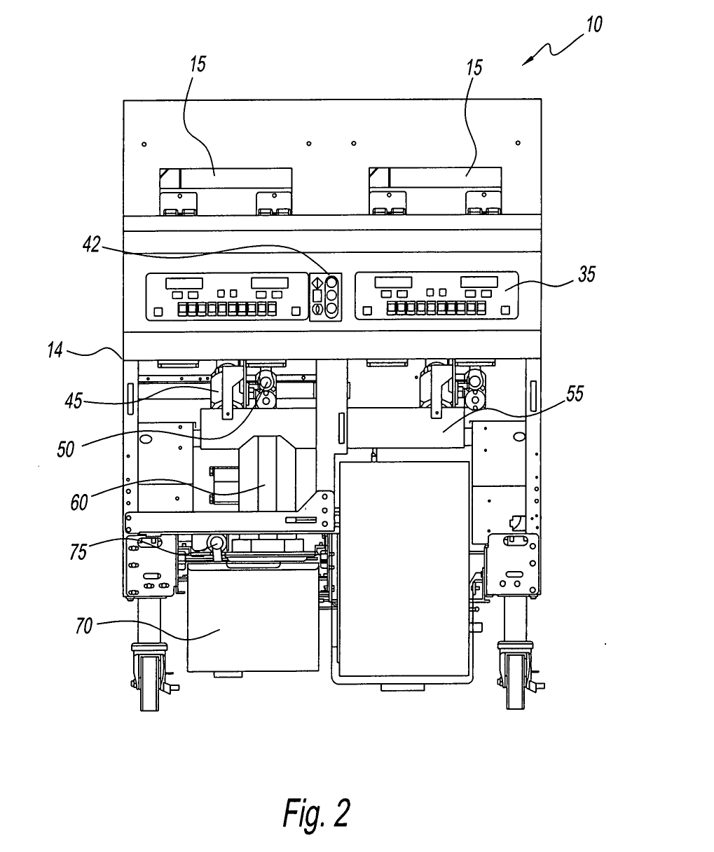

Referring to FIGS. 2 through 7, the process of filtering the oil will be described. Cooking oil must be of a temperature that is warm enough to support a filtration cycle so that oil may freely flow through filtering cycle components. The oil temperature must be in a range of from 270° F. to 300° F. If oil is too cool to commence a filtration cycle, feedback from temperature sensor 25 immersed in oil prevents initiation of an automatic filtration cycle. Alternatively, a user can disable the filtration cycle and warm the oil to an acceptable temperature. Once the oil has reached an acceptable temperature, such as above 270° F., linear actuator 50 can be actuated to open drain valve 45 and allow oil to drop into manifold 55. The user can also initiate the filtration cycle after the acceptable temperature has been sensed, based upon the number of basket uses or if within their judgement a filtration cycle is needed.

Once a substantial amount of oil has drained from fryer pot 15 into filter pan 70 from manifold 55, temperature sensor 25 in fryer pot 15 is exposed to an ambient air temperature. When temperature sensor 25 senses a 10° F. to 20° F. temperature drop below the set oil temperature, controller 40 energizes linear actuator 52 to open return valve 90 and pump and motor assembly 85 are switched on to return oil back to fryer pot 15. Sensor 25 senses a temperature of from approximately 250° F. to 280° F. The pumping action pulls the oil through filter pad 72 located in the bottom of filter pan 70 and forces clean filtered oil through return valve 90. The temperature drop sensed by sensor 25 informs controller that oil is no longer in fryer pot 15 and that pump and motor assembly 85 can be switched on to commence filling of fryer pot 15. Were filtration system only time based, the pump and motor assembly 85 may improperly commence operation and run in the absence of oil and cause premature component failure.

After filtered oil is pushed through opened return valve 90, it is forced through a narrow slot or several slots 100 at lower edge of fryer pot 15 and sprayed over fryer pot lower surface. These slots are from 2 to 5 inches long, 0.05 to 0.10 inches in height, and from 1 to 5 in number. The force with which oil is sprayed back over lower surface of fryer pot 15 is strong enough to push remaining heavy debris that did not initially flow through drain valve 45 at commencement of filtering cycle, but not so great as to force oil to splash out of the fryer pot 15. By having an oil flow rate of approximately 3 to 9 gallons/minute through a limited size pump and motor assembly 85, oil is prevented from splashing out of fryer pot 15. The sprayed oil and additional debris will then flow through drain valve 45. The amount of time for spraying the oil from return valve 90 back and though the drain valve 45 is predetermined and set in controller 40 for a duration of 15 to 30 seconds. During this time, cooking oil is repeatedly cycled through filtration system. After 15 to 30 seconds, linear actuator 50 is activated to close drain valve 45 while pump and motor assembly 85 return oil to fryer pot 15. The repeated or polishing cycles filters the oil to ensure that substantially all food particles have been removed from the cooking oil and the fryer pot 15. The polishing filtration cycles eliminate the need for the cooking oil to be replaced prematurely and therefore extends the useful life of the cooking oil. Further the centralized control of drain valve 45, return valve 90, and pump and motor assembly 85 provides sensory feedback to ensure that the filtering cycle is performed in the correct timed sequence.

Approximately 15 to 30 seconds after drain valve 45 is closed, heating elements 20 are automatically energized to warm cooking oil that has been returned to fryer pot 15. After 20 to 45 more seconds, the volume of cooking oil in fryer pot 15 is great enough so that temperature sensor 95 on fryer pot wall is able to sense an increase in temperature because it is immersed. When sensor 95 senses approximately 5 to 10 seconds of rising temperature the oil is considered to be returned substantially to the pot. Twenty to forty-five additional seconds of bubbling insure that the oil is completely returned to the fryer pot from filter pan 70. At this time, pump and motor assembly 85 are de-energized and linear actuator 52 is energized to close return valve 90.

While the instant disclosure has been described to incorporate linear actuators, either hydraulic or pneumatic pistons could also be used for opening and closing the drain and return valves of the instant disclosure.

The present invention having been thus described with particular reference to the preferred forms thereof, it will be obvious that various changes and modifications may be made therein without departing from the spirit and scope of the present invention as defined in the disclosure.

1. An automatic filtration system for cooking oil in a deep fryer comprising:
a deep fryer;
a plurality of fryer pots disposed in said deep fryer, each of said plurality of fryer pots having a first temperature sensor, a second temperature sensor, a drain valve and return valve associated therewith; and
a controller, said controller being capable of count a number of cooking cycles
wherein after said first temperature sensor senses a first predetermined temperature, the cooking oil drains from said fryer pot through said drain valve and when said second temperature sensor senses second predetermined temperature, the cooking oil has substantially returned to said fryer pot through said return valve.

2. The system according claim 1, further comprising a pair of actuators, wherein one of said actuators is activated by said controller to open and close said drain valve and the other of said pair of actuators is activated by said controller to open and close said return valve.

3. The system according to claim 1, further comprising a filter pan associated with each of said plurality of fryer pots, wherein cooking oil passes through said filter pan before returning to said fryer pot.

4. The system according to claim 3, wherein said filter pan further comprises a crumb basket and a filter pad.

5. The system according to claim 4, wherein crumb basket is disposed above said filter pad in said filter pan to filter large crumbs from the cooking oil.

6. The system according to claim 1, further comprising at least one slot disposed at a lower edge of each of said plurality of fryer pots proximate said return valve.

7. The system according to claim 6, further comprising a pump and a motor, wherein said pump and said motor pump oil from said filter pan through said return valve to said fryer pot and said at least one slot.

8. The system according to claim 6, wherein said at least one slot ranges in number from one slot to five slots.

9. The system according to claim 1, wherein after said first temperature sensor detects approximately a 10° F. to 20° F. temperature decrease from said first predetermined temperature, said pump and motor are activated to return oil to said fryer pot.

10. The system according to claim 7, wherein said pump and said motor repeatedly cycle the cooking oil from said drain and through said return valve approximately 15 seconds to 30 seconds to complete a filtration cycle.

11. The system according to claim 10, wherein after said filtration cycle, said drain valve is closed and said pump and said motor return the cooking oil to said fryer pot.

12. The system according to claim 1, wherein said first temperature sensor and said second temperature sensor are bi-metallic temperature sensors.

13. The system according to claim 1, wherein said filtration cycle commences automatically or manually.

14. The system according to claim 1, wherein said first predetermined temperature is from approximately 270° F. to 300° F.

15. The system according to claim 1, wherein said second predetermined temperature is from approximately 250° F. to 280° F.

16. An automatic filtration system for cooking oil in a deep fryer comprising:
a deep fryer;
a plurality of fryer pots disposed in said deep fryer, each of said plurality of fryer pots having a first temperature sensor, a drain valve, a second temperature sensor, a return valve associated therewith and at least one slot proximate said drain valve; and
a controller
wherein after said first temperature sensor senses a first predetermined temperature, the cooking oil drains from said fryer pot through said drain valve and when said second temperature sensor senses a second predetermined temperature the cooking oil has substantially returned to said fryer pot through said return valve and said at least one slot.

17. The system according to claim 16, wherein said controller is pre-programmed to commence a filtration cycle after a predetermined number of cooking cycles have been counted by said controller.

18. The system according claim 16, further comprising a pair of actuators, wherein one of said actuators is activated by said controller to open and close said drain valve and the other of said pair of actuators is activated by said controller to open and close said return valve.

19. The system according to claim 16, further comprising a plurality of fitter pans, wherein one of said plurality of filter pans is associated with each of said plurality of fryer pots, wherein cooking oil passes through each said filter pan before returning to said fryer pot.

20. The system according to claim 16, further comprising a pump and a motor, wherein said pump and said motor pump oil from said filter pan through said return valve to said fryer pot and said at least one slot.

21. The system according to claim 16, wherein said at least one slot ranges from one slot to five slots.

22. The system according to claim 16, wherein said oil drains from said fryer pot through said drain valve and returns to said fryer pot through said return valve repeatedly for approximately 15 seconds to approximately 30 seconds to complete a filtration cycle.

23. The system according to claim 22, wherein after said filtration cycle, said drain valve is closed and said pump and said motor return cooking oil to said fryer pot.

24. The system according to claim 16, wherein said first predetermined temperature is from approximately 270° F. to 300° F.

25. The system according to claim 16, wherein said second predetermined temperature is from approximately 250° F. to 280° F.

26. The system according to claim 16, wherein said second temperature sensor is capable of detecting a increase in temperature as cooking oil is returned to said fryer pot.

27. The system according to claim 27, wherein after said second temperature sensor detects an increase of approximately 5 to 10 seconds of increasing temperature, the cooking oil has substantially returned to said fryer pot.

28. The system according to claim 27, wherein said pump and said motor and said second actuator are deactivated after the cooking oil has returned to said fryer pot.
